(19) United States
(12) Patent Application Publication
(10) Pub. No.: US 2018/0369744 A1
(43) Pub. Date: Dec. 27, 2018

(54) Hybrid Direct-Contact Exchanger

(71) Applicants: Larry Baxter, Orem, UT (US); David Frankman, Provo, UT (US); Aaron Sayre, Spanish Fork, UT (US); Stephanie Burt, Provo, UT (US); Christopher Hoeger, Provo, UT (US); Eric Mansfield, Spanish Fork, UT (US); Nathan Davis, Bountiful, UT (US)

(72) Inventors: Larry Baxter, Orem, UT (US); David Frankman, Provo, UT (US); Aaron Sayre, Spanish Fork, UT (US); Stephanie Burt, Provo, UT (US); Christopher Hoeger, Provo, UT (US); Eric Mansfield, Spanish Fork, UT (US); Nathan Davis, Bountiful, UT (US)

(21) Appl. No.: 15/634,043

(22) Filed: Jun. 27, 2017

(51) Int. Cl. B01D 53/18; F25J 3/08

(52) U.S. Cl. CPC B01D 53/18; F25J 3/08; F25J 2220/02; F25J 2210/70; F25J 2205/32

(57) ABSTRACT

A process and device for separating a vapor from a gas is disclosed. A direct-contact exchanger comprising a droplet-generating apparatus in a top portion of the exchanger and a bubbling apparatus in a bottom portion of the exchanger is provided. An inlet gas, comprising a vapor, is passed through the bubbling apparatus, forming bubbles in a bottoms liquid. The bottoms liquid strips a portion of the vapor and exchanges heat with the bubbles, producing a product liquid and a middle gas. A barren liquid is passed through the droplet-generating apparatus to form droplets of the barren liquid in the top portion. The droplets descend against the middle gas and strip a second portion of the vapor from and exchange heat with the middle gas, producing the bottoms liquid, which collects in the bottom portion, and a product gas.

This invention was made with government support under DE-FE0028697 awarded by The Department of Energy. The government has certain rights in the invention.

### FIELD OF THE INVENTION

This invention relates generally to direct-contact heat and material exchange. More particularly, we are interested in a combined bubbler and spray tower.

### BACKGROUND

Direct-contact heat and material exchange is a process that is used extensively in a broad spectrum of industries. Many types of direct-contact exchangers exist, including spray towers and bubblers. Spray towers are herein defined to include gas-liquid contactors where droplets are formed by liquid nozzles, drip trays, perforated plates, or other droplet producing apparatuses. Bubblers include gas-liquid contactors with bubble trays, bubble plates, spargers, gas nozzles, bubble caps, and similar bubbling apparatuses.

Spray towers benefit from a relatively low pressure drop and good temperature gradients. Bubblers benefit from high heat flux and space efficiency. An exchanger with the benefits of both spray towers and bubblers would be of significant use in direct-contact exchange. The Applicant is unaware of any process that combines these two direct-contact processes in one unit operation.

U.S. Pat. No. 965,116, to Morison teaches a cooling tower. The present disclosure differs from this prior art disclosure in that the prior art disclosure only utilizes a spray tower. This prior art disclosure is pertinent and may benefit from the devices disclosed herein and is hereby incorporated for reference in its entirety for all that it teaches.

U.S. Pat. No. 2,568,875, to Hartmann teaches a spray-type absorption tower. The present disclosure differs from this prior art disclosure in that the prior art disclosure only utilizes a spray tower. This prior art disclosure is pertinent and may benefit from the devices disclosed herein and is hereby incorporated for reference in its entirety for all that it teaches.

U.S. Pat. No. 5,545,356, to Curtis, et al., teaches an industrial cooling tower. The present disclosure differs from this prior art disclosure in that the prior art disclosure only utilizes a spray tower. This prior art disclosure is pertinent and may benefit from the devices disclosed herein and is hereby incorporated for reference in its entirety for all that it teaches.

U.S. Pat. No. 2292350, to Brandt, teaches a heat exchange apparatus. The present disclosure differs from this prior art disclosure in that the prior art disclosure only utilizes a bubbler tower. This prior art disclosure is pertinent and may benefit from the devices disclosed herein and is hereby incorporated for reference in its entirety for all that it teaches.

U.S. Pat. No. 2,833,527, to Kohl, et al., teaches an industrial cooling tower. The present disclosure differs from this prior art disclosure in that the prior art disclosure only utilizes a bubbler tower. This prior art disclosure is pertinent and may benefit from the devices disclosed herein and is hereby incorporated for reference in its entirety for all that it teaches.

U.S. Pat. No. 5,942,164, to Tran, teaches a combined heat and mass transfer device for improving a separation process. The present disclosure differs from this prior art disclosure in that the prior art disclosure only utilizes a bubbler tower. This prior art disclosure is pertinent and may benefit from the devices disclosed herein and is hereby incorporated for reference in its entirety for all that it teaches.

### SUMMARY

A process and device for separating a vapor from a gas is disclosed. A direct-contact exchanger comprising a droplet-generating apparatus in a top portion of the exchanger and a bubbling apparatus in a bottom portion of the exchanger is provided. An inlet gas, comprising a vapor, is passed through the bubbling apparatus, forming bubbles in a bottoms liquid. The bottoms liquid strips a portion of the vapor and exchanges heat with the bubbles, producing a product liquid and a middle gas. A barren liquid is passed through the droplet-generating apparatus to form droplets of the barren liquid in the top portion. The droplets descend against the middle gas and strip a second portion of the vapor from and exchange heat with the middle gas, producing the bottoms liquid, which collects in the bottom portion, and a product gas.

The droplet-generating apparatus may comprise one or more nozzles, drip trays, perforated plates, or combinations thereof. The bubbling apparatus may comprise one or more bubble trays, bubble plates, bubble caps, spargers, nozzles, or combinations thereof.

The barren liquid may comprise water, hydrocarbons, liquid ammonia, liquid carbon dioxide, cryogenic liquids, or combinations thereof. The inlet gas may comprise flue gas, syngas, producer gas, natural gas, steam reforming gas, hydrocarbons, light gases, refinery off-gases, organic solvents, steam, ammonia, or combinations thereof. The vapor may comprise carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof. The inlet gas may further comprise entrained solids, the entrained solids comprising salts, biomass, dust, ash, or combinations thereof. The bottoms liquid may be a slurry, comprising entrained solids.

A supplemental stream of the barren liquid may be provided to the bottoms liquid in the bottom portion. A supplemental stream of the inlet gas may be provided to the exchanger above the bottoms liquid.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a direct-contact exchanger for separating a vapor from a gas.

FIG. 2 shows a direct-contact exchanger for separating carbon dioxide from flue gas.

FIG. 3 shows a direct-contact exchanger for separating a vapor from a gas.

FIG. 4 shows a direct-contact exchanger for separating a vapor from a gas.

FIG. 5 shows a direct-contact exchanger for separating a vapor from a gas.

FIG. 6 shows a process for separating a vapor from a gas.

FIG. 7 shows a graph showing temperature versus position in the exchangers of FIGS. 1-5.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

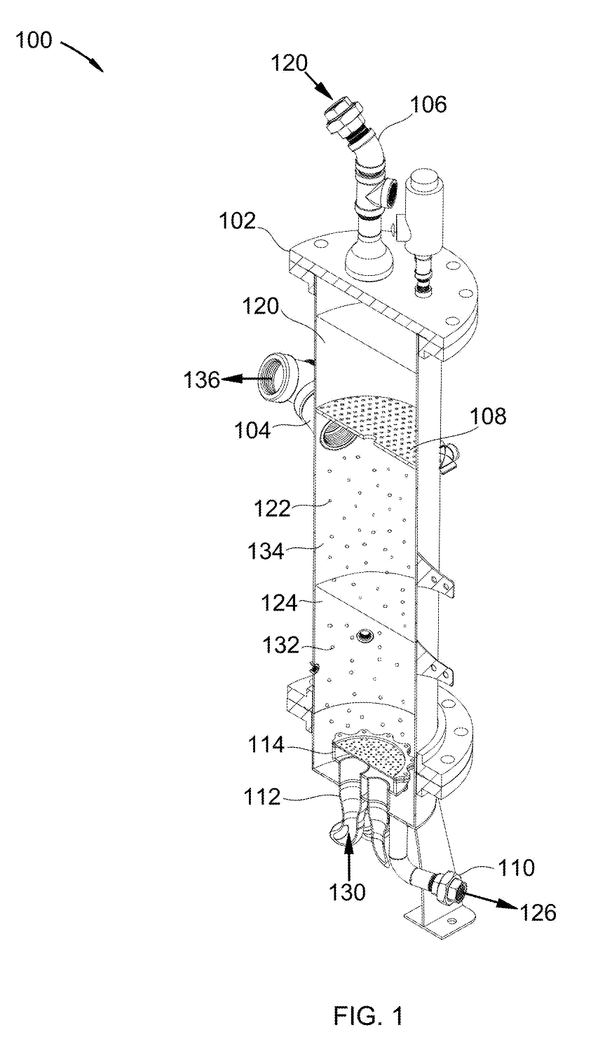

Referring to FIG. 1, a direct-contact exchanger for separating a vapor from a gas is shown at 100, as per one embodiment of the present invention. Exchanger 102 comprises liquid inlet 106, perforated tray 108, gas inlet 112, bubble plate 114, gas outlet 104, and liquid outlet 110. Inlet gas 130 is passed through gas inlet 112 and through bubble plate 114, producing bubbles 132 which bubble through bottoms liquid 124. Inlet gas 130 comprises a vapor. Bottoms liquid 124 strips a first portion of the vapor from and exchanges heat with bubbles 132, producing product liquid 126 and middle gas 134. Barren liquid 120 enters exchanger 102 through liquid inlet 106 and passes through perforated tray 108, producing droplets 122. Droplets 122 descend against middle gas 134 and strip a second portion of the vapor from and exchange heat with middle gas 134, producing bottoms liquid 124 and product gas 136, which leaves exchanger 102 through gas outlet 104.

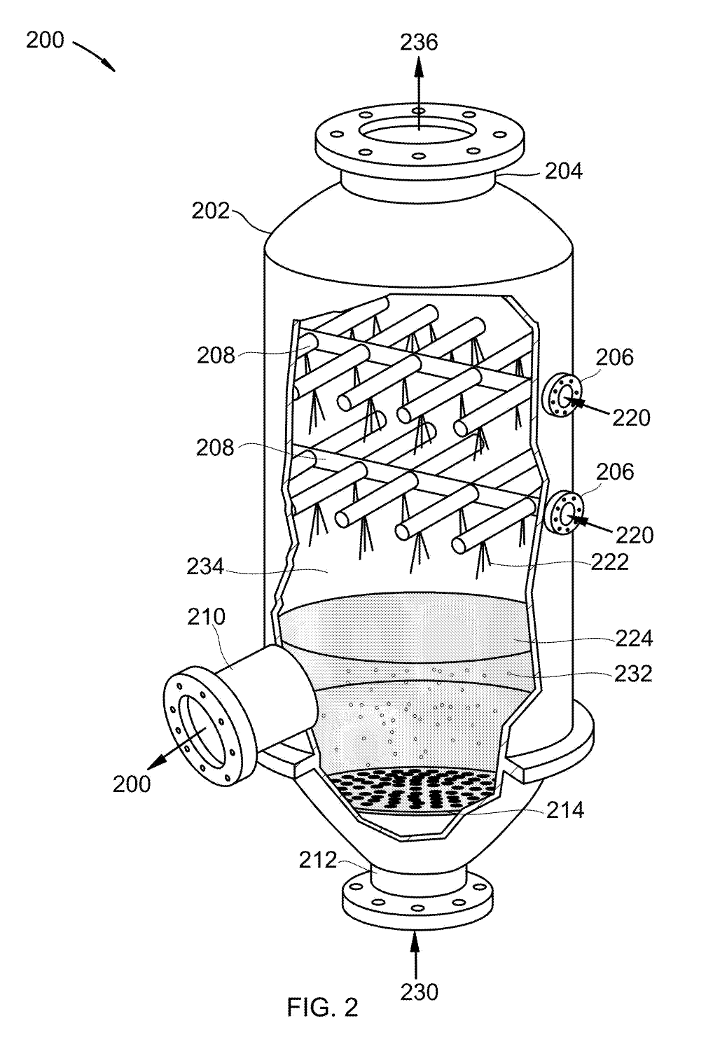

Referring to FIG. 2, a direct-contact exchanger for separating carbon dioxide from flue gas is shown at 200, as per one embodiment of the present invention. Exchanger 202 comprises liquid inlet 206, nozzles 208, gas inlet 212, bubble tray 214, gas outlet 204, and liquid outlet 210. Flue gas 230 is passed through gas inlet 212 and through bubble tray 214, producing bubbles 232 which bubble through bottoms liquid 224. Flue gas 230 comprises carbon dioxide. Bottoms liquid 224 strips a first portion of the carbon dioxide from and exchanges heat with bubbles 232, producing product liquid 226 and middle gas 234. Isopentane 220 enters exchanger 202 through liquid inlet 206 and passes through nozzles 208, producing droplets 222. Droplets 222 descend against middle gas 234 and strip a second portion of the carbon dioxide from and exchange heat with middle gas 234, producing bottoms liquid 224 and stripped-flue gas 236, which leaves exchanger 202 through gas outlet 204. In some embodiments, isopentane 220 is replaced by other organic solvents.

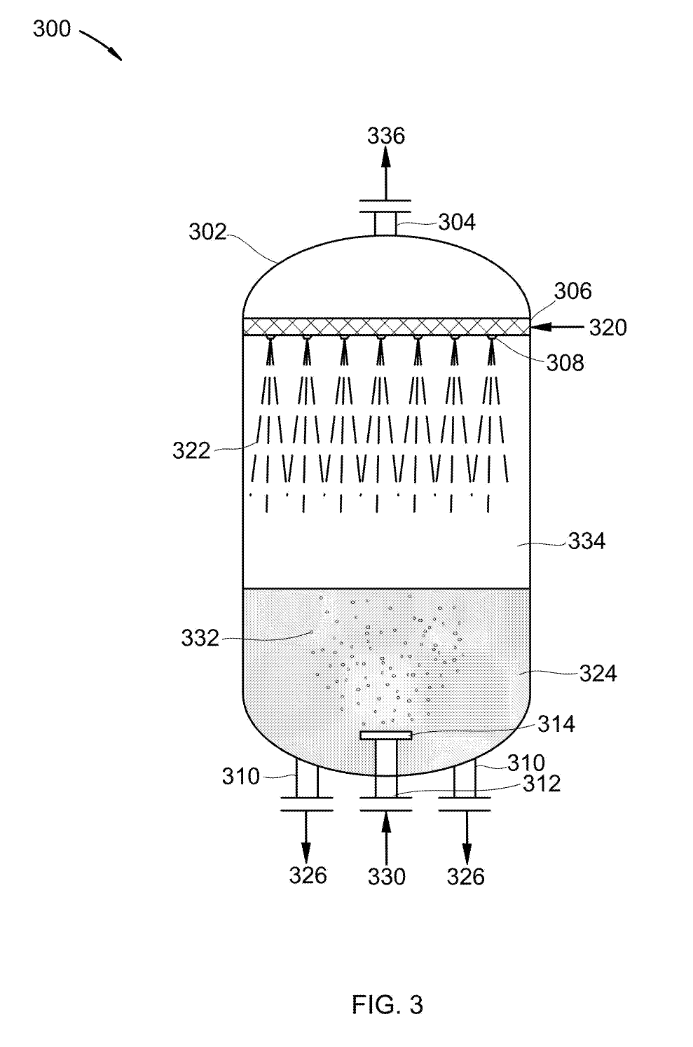

Referring to FIG. 3, a direct-contact exchanger for separating a vapor from a gas is shown at 300, as per one embodiment of the present invention. Exchanger 302 comprises liquid inlet 306, nozzles 308, gas inlet 312, bubble plate 314, gas outlet 304, and liquid outlet 310. Inlet gas 330 is passed through gas inlet 312 and through bubble plate 314, producing bubbles 332 which bubble through bottoms liquid 324. Flue gas 330 comprises a vapor. Bottoms liquid 324 strips a first portion of the vapor from and exchanges heat with bubbles 332, producing product liquid 326 and middle gas 334. Barren liquid 320 enters exchanger 302 through liquid inlet 306 and passes through nozzles 308, producing droplets 322. Droplets 322 descend against middle gas 334 and strip a second portion of the vapor from and exchange heat with middle gas 334, producing bottoms liquid 324 and product gas 336, which leaves exchanger 302 through gas outlet 304.

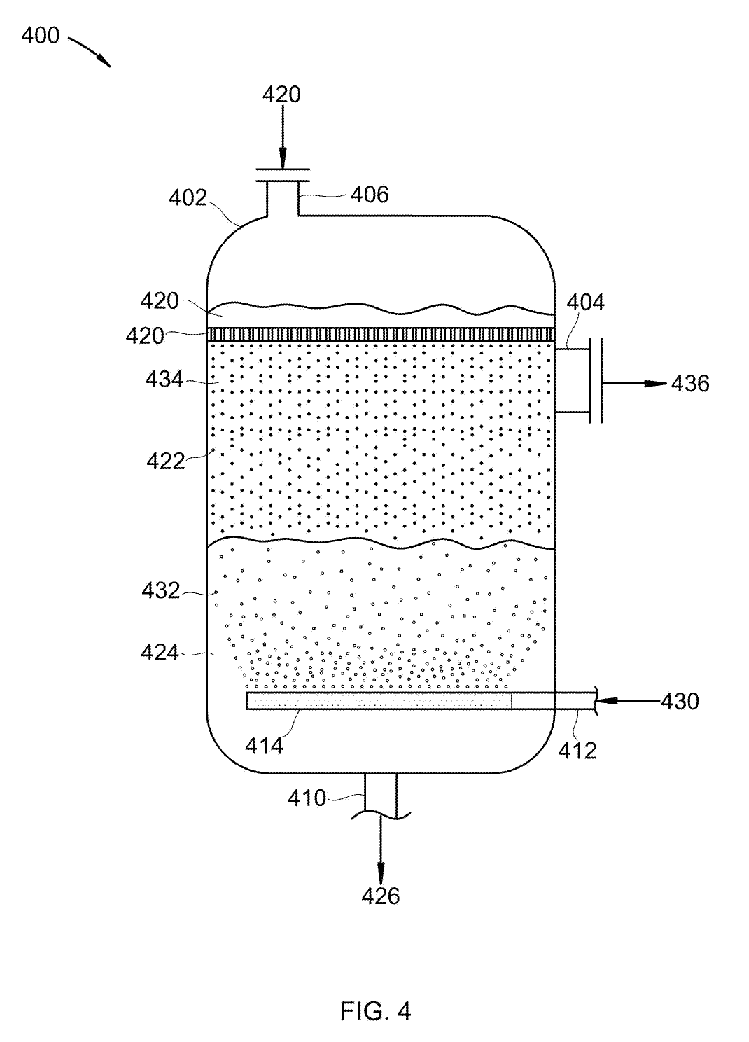

Referring to FIG. 4, a direct-contact exchanger for separating a vapor from a gas is shown at 400, as per one embodiment of the present invention. Exchanger 402 comprises liquid inlet 406, perforated plate 408, gas inlet 412, sparger 414, gas outlet 404, and liquid outlet 410. Inlet gas 430 is passed through gas inlet 412 and through sparger 414, producing bubbles 432 which bubble through bottoms liquid 424. Flue gas 430 comprises a vapor. Bottoms liquid 424 strips a first portion of the vapor from and exchanges heat with bubbles 432, producing product liquid 426 and middle gas 434. Barren liquid 420 enters exchanger 402 through liquid inlet 406 and passes through nozzles 408, producing droplets 422. Droplets 422 descend against middle gas 434 and strip a second portion of the vapor from and exchange heat with middle gas 434, producing bottoms liquid 424 and product gas 436, which leaves exchanger 402 through gas outlet 404.

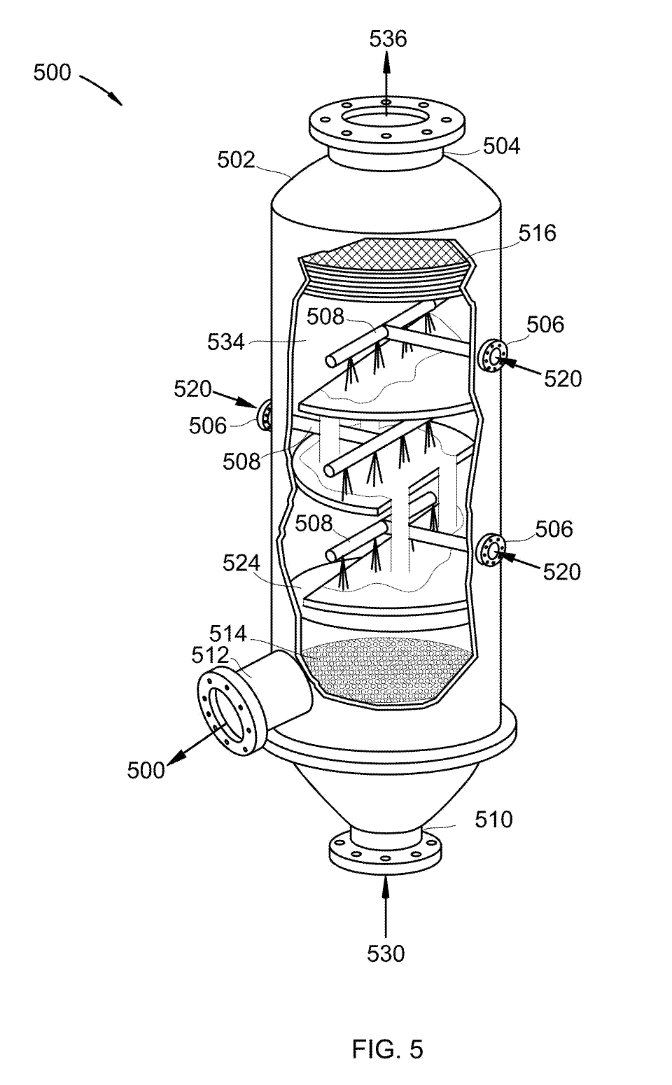

Referring to FIG. 5, a direct-contact exchanger for separating a vapor from a gas is shown at 500, as per one embodiment of the present invention. Exchanger 502 comprises liquid inlet 506, perforated plate 508, gas inlet 512, bubble caps 514, gas outlet 504, liquid outlet 510, and de-mister 516. Inlet gas 530 is passed through gas inlet 512 and through bubble caps 514, producing bubbles (not shown) which bubble through bottoms liquid 524. Flue gas 530 comprises a vapor. Bottoms liquid 524 strips a first portion of the vapor from and exchanges heat with the bubbles, producing product liquid 526 and middle gas 534. Barren liquid 520 enters exchanger 502 through liquid inlet 506 and passes through nozzles 508, producing droplets 522. Droplets 522 descend against middle gas 534 and strip a second portion of the vapor from and exchange heat with middle gas 534, producing bottoms liquid 524 and product gas 536, which leaves exchanger 502 through gas outlet 504.

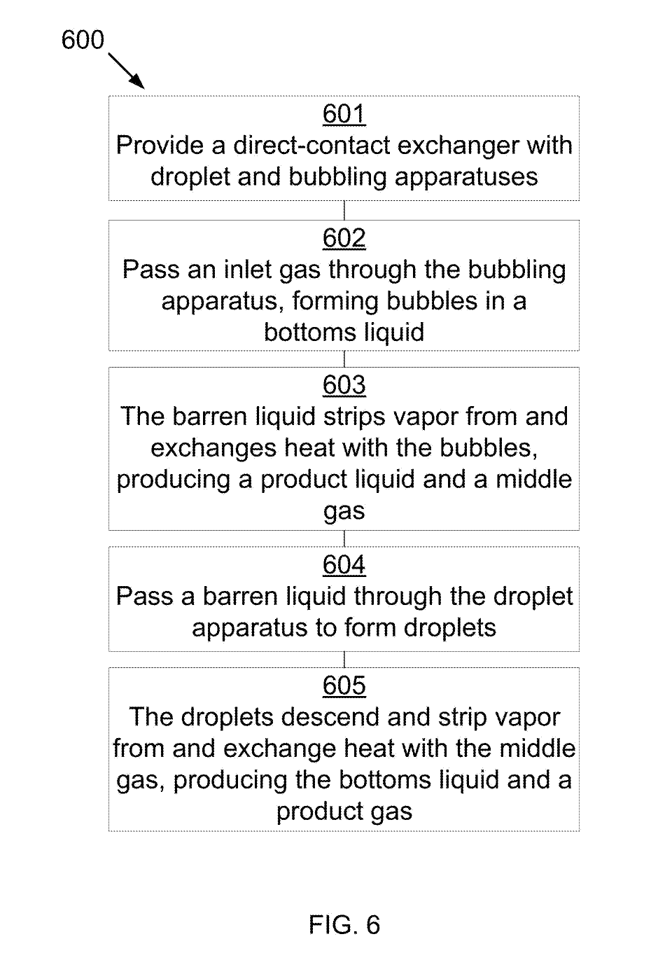

Referring to FIG. 6, a process for separating a vapor from a gas is shown at 600, as per one embodiment of the present invention. A direct-contact exchanger is provided, comprising a droplet-generating apparatus in a top portion of the exchanger and a bubbling apparatus in a bottom portion of the exchanger 601. An inlet gas, comprising a vapor, is passed through the bubbling apparatus, forming bubbles in a bottoms liquid 602. The bottoms liquid strips a first portion of the vapor and exchanges heat with the bubbles, producing a product liquid and a middle gas 603. A barren liquid is passed through the droplet-generating apparatus to form droplets of the barren liquid in the top portion 604. The droplets descend against the middle gas and strip a second portion of the vapor from and exchange heat with the middle gas, producing the bottoms liquid, which collects in the bottom portion, and a product gas 605.

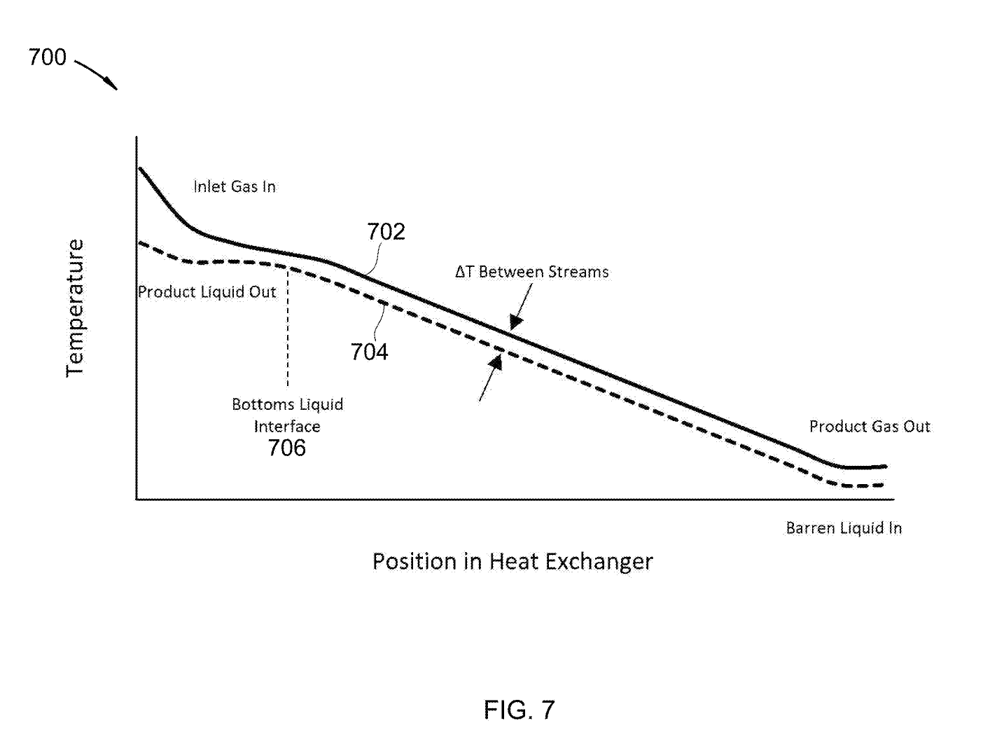

Referring to FIG. 7, a graph showing temperature versus position in the exchangers of FIGS. 1-5 is shown at 700, as per one embodiment of the present invention. The temperature of the gas as it passes from the inlet gas (left) to the product gas (right) is shown by curve 702. The temperature of the liquid as it passes from the barren liquid (right) to the product liquid (left) is shown by curve 704. As inlet gas bubbles into the liquid, the temperature of the gas rapidly approaches the temperature of the bottoms liquid. The gas exits the liquid at bottoms liquid interface 706 and curve 702 continues to drop with a steady temperature difference, ΔT, versus curve 704 as the gas and droplets exchange heat and material until the gas passes out of the exchanger. This graph shows the hybrid spray tower and bubbler in operation. The combination provides the low pressure drop and good temperature gradient of a spray tower, while still having the high heat flux and space efficiency that a bubbler offers. Further, the hybrid is upset-tolerant. Specifically, the bubbler can provide significant heat exchange in a small space, and thus provide the ability to produce a substantially constant interface 706 temperature even if the inlet gas has significant variations in initial temperature. The bottoms liquid would act as a thermal ‘capacitor’ or ‘dampener.’

In some embodiments, the droplet-generating apparatus comprises one or more nozzles, drip trays, perforated plates, or combinations thereof. In some embodiments, the bubbling apparatus comprises one or more bubble trays, bubble plates, bubble caps, spargers, nozzles, or combinations thereof.

In some embodiments, the barren liquid comprises water, hydrocarbons, liquid ammonia, liquid carbon dioxide, cryogenic liquids, or combinations thereof. In some embodiments, the inlet gas comprises flue gas, syngas, producer gas, natural gas, steam reforming gas, hydrocarbons, light gases, refinery off-gases, organic solvents, steam, ammonia, or combinations thereof. In some embodiments, the vapor comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof. In some embodiments, the inlet gas further comprises entrained solids, the entrained solids comprising salts, biomass, dust, ash, or combinations thereof. In some embodiments, the bottoms liquid is a slurry, comprising the entrained solids and solid forms of the vapor.

In some embodiments, a supplemental stream of the barren liquid is added to the bottoms liquid in the bottom portion.

Combustion flue gas consists of the exhaust gas from a fireplace, oven, furnace, boiler, steam generator, or other combustor. The combustion fuel sources include coal, hydrocarbons, and biomass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entrained dust and soot will also be present in all combustion flue gas streams. The method disclosed applies to any combustion flue gases. Dried combustion flue gas has had the water removed.

Syngas consists of hydrogen, carbon monoxide, and carbon dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

1. A direct-contact exchanger for separating a vapor from a gas comprising:
a droplet-generating apparatus in a top portion of the exchanger and a bubbling apparatus in a bottom portion of the exchanger, wherein:
a bubbling apparatus passes bubbles of an inlet gas into a bottoms liquid, the inlet gas comprising a vapor, wherein the bottoms liquid strips a first portion of the vapor from and exchanges heat with the bubbles, producing a product liquid and a middle gas; and,
the droplet-generating apparatus passes droplets of a barren liquid into the top portion, the droplets descending against the middle gas and stripping a second portion of the vapor from and exchanging heat with the middle gas, producing the bottoms liquid, which collects in the bottom portion, and a product gas.

2. The exchanger of claim 1, wherein the droplet-generating apparatus comprises one or more nozzles, drip trays, perforated plates, or combinations thereof.

3. The exchanger of claim 1, wherein the bubbling apparatus comprises one or more bubble trays, bubble plates, bubble caps, spargers, nozzles, or combinations thereof.

4. The exchanger of claim 1, wherein the barren liquid comprises water, hydrocarbons, liquid ammonia, liquid carbon dioxide, cryogenic liquids, or combinations thereof.

5. The exchanger of claim 4, wherein the inlet gas comprises flue gas, syngas, producer gas, natural gas, steam reforming gas, hydrocarbons, light gases, refinery off-gases, organic solvents, steam, ammonia, or combinations thereof.

6. The exchanger of claim 5, wherein the vapor comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

7. The exchanger of claim 6, wherein the inlet gas further comprises entrained solids, the entrained solids comprising salts, biomass, dust, ash, or combinations thereof.

8. The exchanger of claim 7, wherein the bottoms liquid is a slurry, comprising the entrained solids and solid forms of the vapor.

9. The exchanger of claim 1, wherein a supplemental stream of the barren liquid is added to the bottoms liquid in the bottom portion.

10. A direct-contact exchanger for separating a vapor from a gas comprising:
a droplet-generating apparatus in a top portion of the exchanger and a bubbling apparatus in a bottom portion of the exchanger, wherein:
the droplet-generating apparatus comprises one or more nozzles, drip trays, perforated plates, or combinations thereof;
the bubbling apparatus comprises one or more bubble trays, bubble plates, bubble caps, spargers, nozzles, or combinations thereof;
a bubbling apparatus passes bubbles of an inlet gas into a bottoms liquid, the inlet gas comprising a vapor, wherein the bottoms liquid strips a first portion of the vapor from and exchanges heat with the bubbles, producing a product liquid and a middle gas;
the droplet-generating apparatus passes droplets of a barren liquid into the top portion, the droplets descending against the middle gas and stripping a second portion of the vapor from and exchanging heat with the middle gas, producing the bottoms liquid, which collects in the bottom portion, and a product gas;
the barren liquid comprises water, hydrocarbons, liquid ammonia, liquid carbon dioxide, cryogenic liquids, or combinations thereof;
the inlet gas comprises flue gas, syngas, producer gas, natural gas, steam reforming gas, hydrocarbons, light gases, refinery off-gases, organic solvents, steam, ammonia, or combinations thereof;
the vapor comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

11. A process for separating a vapor from a gas comprising:
providing a direct-contact exchanger comprising a droplet-generating apparatus in a top portion of the exchanger and a bubbling apparatus in a bottom portion of the exchanger;
passing an inlet gas, comprising a vapor, through the bubbling apparatus, forming bubbles in a bottoms liquid, the bottoms liquid stripping a first portion of the vapor and exchanging heat with the bubbles, producing a product liquid and a middle gas; and,
passing a barren liquid through the droplet-generating apparatus to form droplets of the barren liquid in the top portion, the droplets descending against the middle gas and stripping a second portion of the vapor from and exchanging heat with the middle gas, producing the bottoms liquid, which collects in the bottom portion, and a product gas.

12. The process of claim 11, providing the droplet-generating apparatus comprising one or more nozzles, drip trays, perforated plates, or combinations thereof.

13. The process of claim 11, providing the bubbling apparatus comprising one or more bubble trays, bubble plates, bubble caps, spargers, nozzles, or combinations thereof.

14. The process of claim 11, wherein the barren liquid comprises water, hydrocarbons, liquid ammonia, liquid carbon dioxide, cryogenic liquids, or combinations thereof.

15. The process of claim 14, wherein the inlet gas comprises flue gas, syngas, producer gas, natural gas, steam reforming gas, hydrocarbons, light gases, refinery off-gases, organic solvents, steam, ammonia, or combinations thereof.

16. The process of claim 15, wherein the vapor comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof.

17. The process of claim 16, wherein the inlet gas further comprises entrained solids, the entrained solids comprising salts, biomass, dust, ash, or combinations thereof.

18. The process of claim 17, wherein the bottoms liquid is a slurry, comprising the entrained solids and solid forms of the vapor.

19. The process of claim 11, further comprising providing a supplemental stream of the barren liquid to the bottoms liquid in the bottom portion.

20. A process for separating a vapor from a gas comprising:
providing a direct-contact exchanger comprising a droplet-generating apparatus in a top portion of the exchanger and a bubbling apparatus in a bottom portion of the exchanger, wherein:
the droplet-generating apparatus comprises one or more nozzles, drip trays, perforated plates, or combinations thereof;
the bubbling apparatus comprises one or more bubble trays, bubble plates, bubble caps, spargers, nozzles, or combinations thereof;
passing an inlet gas, comprising a vapor, through the bubbling apparatus, forming bubbles in a bottoms liquid, the bottoms liquid stripping a first portion of the vapor and exchanging heat with the bubbles, producing a product liquid and a middle gas, wherein:
the inlet gas comprises flue gas, syngas, producer gas, natural gas, steam reforming gas, hydrocarbons, light gases, refinery off-gases, organic solvents, steam, ammonia, or combinations thereof;
the vapor comprises carbon dioxide, nitrogen oxide, sulfur dioxide, nitrogen dioxide, sulfur trioxide, hydrogen sulfide, hydrogen cyanide, water, mercury, hydrocarbons, pharmaceuticals, or combinations thereof and,
passing a barren liquid through the droplet-generating apparatus to form droplets of the barren liquid in the top portion, the droplets descending against the middle gas and stripping a second portion of the vapor from and exchanging heat with the middle gas, producing the bottoms liquid, which collects in the bottom portion, and a product gas, wherein:
the barren liquid comprises water, hydrocarbons, liquid ammonia, liquid carbon dioxide, cryogenic liquids, or combinations thereof.
